(19) United States
(12) Patent Application Publication
(10) Pub. No.: US 2022/0402182 A1
(43) Pub. Date: Dec. 22, 2022

(54) CONVEYOR DEVICE FOR MOVING MOLDS

(71) Applicants: Canon Virginia, Inc., Newport News, VA (US); Canon U.S.A., Inc., Melvillle, NY (US)

(72) Inventors: Koki Kodaira, Tokyo (JP); Yuichi Yanahara, Moriyama (JP); Junko Tajima, Amsterdam (NL)

(21) Appl. No.: 17/833,701

(22) Filed: Jun. 6, 2022

Related U.S. Application Data
(60) Provisional application No. 63/213,623, filed on Jun. 22, 2021.

(51) Int. Cl. B29C 45/33; B29C 45/04; B29C 45/17

(52) U.S. Cl. CPC B29C 45/332; B29C 45/0408; B29C 45/1742

(57) ABSTRACT

An injection molding system including an injection molding machine including at least one opening on each of a first side surface and a second side surface for conveying at least one mold, wherein the improvement to the injection molding system includes at least one actuator for conveying at least three different molds through at least one of the at least one openings, and at least one guiding element for guiding at least one cable connected to a first mold located between at least two other molds to a location external to the injection molding machine via an opening of the injection molding machine.

### CROSS-REFERENCE TO RELATED APPLICATION

This application claims the benefit of U.S. Provisional Application 63/213,623, which was filed on Jun. 22, 2021.

### FIELD

The disclosure herein relates to an injection molding system.

### BACKGROUND

Manufacturing of molded parts by an injection molding machine includes injecting a resin into a mold after clamping the mold, pressing the resin into the mold at a high pressure in order to compensate for a volume decrease due to solidification of the resin, keeping the molded part in the mold until the resin solidifies, and ejecting the molded part from the mold. The injection molding process is repeatedly performed to obtain a desired number of molded parts. After a predetermined number of moldings are performed with one mold, the mold is ejected from the injection molding machine, the next mold is setup, the next mold is inserted into the injection molding machine, and then the predetermined number of injection moldings with the next mold is performed.

In the above-described molding approach, a method that uses two molds with one injection molding machine has been proposed. For example, US 2018/0009146/Japanese patent publication No. 2018-001738/VN20160002505 are seen to discuss a system in which conveying machines are arranged on both sides of an injection molding machine. FIG. 1 illustrates an injection molding system of US 2018/0009146/Japanese patent publication No. 2018-001738/VN20160002505.

In the above-described molding approach, an issue can arise when injection molding is performed using three or more molds. For example, arranging power supply cables, arranging cooling liquid channels, etc., can be difficult.

### SUMMARY

An injection molding system including an injection molding machine including at least one opening on each of a first side surface and a second side surface for conveying at least one mold, wherein the improvement to the injection molding system includes at least one actuator for conveying at least three different molds through at least one of the at least one openings, and at least one guiding element for guiding at least one cable connected to a first mold located between at least two other molds to a location external to the injection molding machine via an opening of the injection molding machine.

### BRIEF DESCRIPTION OF THE DRAWINGS

The accompanying drawings, which are incorporated herein and form part of the specification, illustrate various embodiments, objects, features, and advantages of the present disclosure.

FIG. 1 illustrates an injection molding system.

FIG. 2 is a side view of an injection molding machine.

FIG. 3 is an end view of a fixed platen.

FIG. 4 illustrates an injection molding system according to an exemplary embodiment.

FIGS. 5A-5G illustrate molds and their linking mechanisms according to an exemplary embodiment.

FIGS. 6A-6C illustrate a configuration of an injection molding system where a mold is in an injection molding operation position according to an exemplary embodiment.

FIGS. 7A-7C illustrate a configuration of an injection molding system where another mold is in an injection molding operation position according to an exemplary embodiment.

FIGS. 8A-8C illustrate a configuration of an injection molding system where yet another mold is in an injection molding operation position according to an exemplary embodiment.

FIGS. 9A-9C illustrate a configuration of an injection molding system where a first mold is in an injection molding operation position according to an exemplary embodiment.

FIGS. 10A-10B illustrate a configuration of an injection molding system where another mold is in an injection molding operation position according to an exemplary embodiment.

FIGS. 11A-11C illustrate a configuration of an injection molding system where yet another mold is in an injection molding operation position according to an exemplary embodiment.

FIGS. 12A-12B illustrate a flowchart illustrating a molding process.

FIG. 13 illustrates a timing chart of an injection molding process according to an exemplary embodiment.

FIG. 14 illustrates a configuration example of a plurality of molds and their linking mechanisms according to an exemplary embodiment.

Throughout the Figures, the same reference numerals and characters, unless otherwise stated, are used to denote like features, elements, components or portions of the illustrated embodiments. While the subject disclosure is described in detail with reference to the Figures, it is done so in connection with the illustrative exemplary embodiments. It is intended that changes and modifications can be made to the described exemplary embodiments without departing from the true scope and spirit of the subject disclosure as defined by the appended claims.

### DESCRIPTION OF THE EMBODIMENTS

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

With reference to the drawings, an injection molding system according to an embodiment of the present disclosure will be explained. The arrow symbols X and Y in each Figure indicate horizontal directions that are orthogonal to each other, and the arrow symbol Z indicates a vertical (upright) direction with respect to the ground.

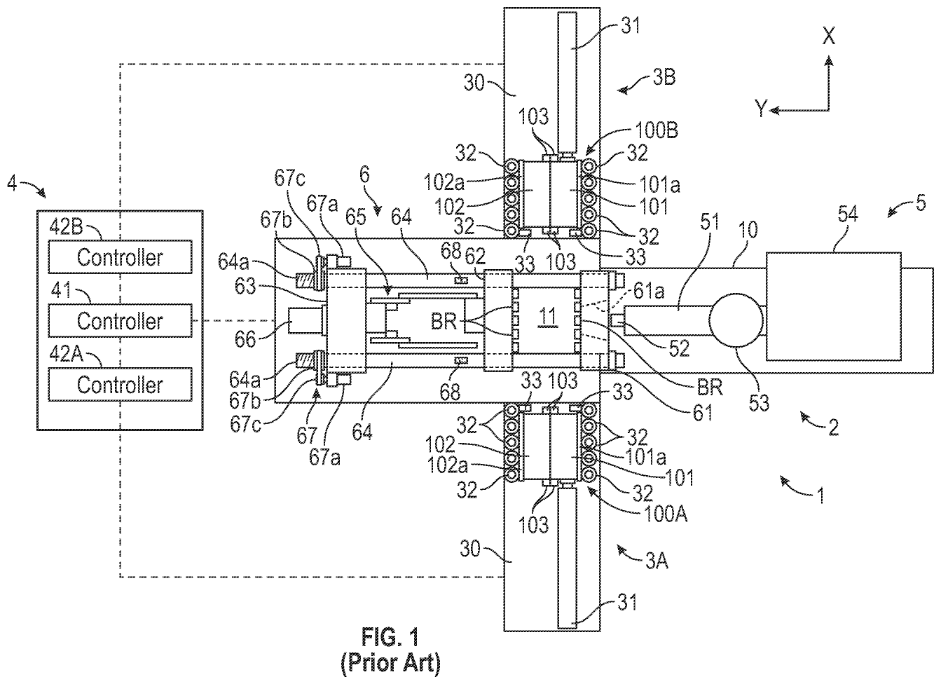

FIGS. 1-3 illustrate injection molding system 1 of US 2018/0009146/Japanese patent publication No. 2018-001738/VN20160002505 and are being provided herein for information/description purposes only.

The injection molding system 1 includes an injection molding machine 2, conveying machines 3A and 3B, and a control apparatus 4. The injection molding system 1 manufactures a molded part while alternating a plurality of molds using the conveying machines 3A and 3B for the one injection molding machine 2. Two molds, 100A and 100B are used.

The mold 100A/100B is a pair of a fixed mold 101 and a movable mold 102, which is opened/closed in relation to the fixed mold 101. The molded part is molded by injecting a molten resin into a cavity formed between the fixed mold 101 and the movable mold 102. Clamping plates 101a and 102a are respectively fixed to the fixed mold 101 and the movable mold 102. The clamping plates 101a and 102a are used to lock the mold 100A/100B to a molding operation position 11 (mold clamping position) of the injection molding machine 2.

For the mold 100A/100B, a self-closing unit 103 is provided for maintaining a closed state between the fixed mold 101 and the movable mold 102. The self-closing unit 103 enables preventing the mold 100A/100B from opening after unloading the mold 100A/100B from the injection molding machine 2. The self-closing unit 103 maintains the mold 100A/100B in a closed state using a magnetic force. The self-closing unit 103 located at a plurality of locations along opposing surfaces of the fixed mold 101 and the movable mold 102. The self-closing unit 103 is a combination of an element on the side of the fixed mold 101 and an element on the side of the movable mold 102. For the self-closing unit 103, typically two or more pair are installed for one of the molds 100A and 100B.

A conveying machine 3A loads and unloads the mold 100A onto/from the molding operation position 11 of the injection molding machine 2. A conveying machine 3B loads and unloads the mold 100B onto/from the molding operation position 11. The conveying machine 3A, the injection molding machine 2, and the conveying machine 3B are arranged to be lined up in this order in the X-axis direction. In other words, the conveying machine 3A and the conveying machine 3B are arranged laterally with respect to the injection molding machine 2 to sandwich the injection molding machine 2 in the X-axis direction. The conveying machines 3A and 3B are arranged to face each other, the conveying machine 3A is arranged on one side laterally of the injection molding machine 2, and the conveying machine 3B is arranged on the other side respectively adjacent. The molding operation position 11 is positioned between the conveying machine 3A and the conveying machine 3B. The conveying machines 3A and 3B respectively include a frame 30, a conveyance unit 31, a plurality of rollers 32, and a plurality of rollers 33.

The frame 30 is a skeleton of the conveying machine 3A and 3B, and supports the conveyance unit 31, and the pluralities of rollers 32 and 33. The conveyance unit 31 is an apparatus that moves the mold 100A/100B back and forth in the X-axis direction, and that removes and inserts the mold 100A/100B in relation to the molding operation position 11.

The conveyance unit 31 is an electrically driven cylinder with a motor as a driving source, and includes a rod that moves forward/backward in relation to the cylinder. The cylinder is fixed to the frame 30, and the fixed mold 101 is fixed to the edge portion of the rod. For the conveyance unit 31 both a fluid actuator and an electric actuator can be used, where the electric actuator can provide better precision of control of the position or the speed when conveying the mold 100A/100B. The fluid actuator can be an oil hydraulic cylinder, or an air cylinder, for example. The electric actuator can, in addition to being an electrically driven cylinder, be a rack-and-pinion mechanism with a motor as the driving source, a ball screw mechanism with a motor as the driving source, or the like.

The conveyance unit 31 is arranged independently for each of the conveying machines 3A and 3B. However, a common support member that supports the molds 100A and 100B can be used, and a single common conveyance unit 31 can be arranged for this support member. A case where the conveyance unit 31 is arranged independently for each of the conveying machines 3A and 3B enables handling cases where a movement strokes differ between the mold 100A and the mold 100B when conveying. For example, a case where molds cannot be conveyed simultaneously since the widths of the molds (the width in the X direction) differ or the thickness of the molds (the width in the Y direction) differ.

The plurality rollers 32 configure a row of rollers arranged in the X-axis direction, where two rows are configured separated in the Y-axis direction. The plurality of rollers 32 rotate around the axis of revolution in the Z-axis direction, and guide movement in the X-axis direction of the mold 100A/100B contacting the side surfaces of the mold 100A/100B (the side surfaces of the clamping plates 101a and 102a) and supporting the mold 100A/100B from the side. The plurality rollers 33 configure a row of rollers arranged in the X-axis direction, where two rows are configured separated in the Y-axis direction. The plurality of rollers 33 rotate around the axis of revolution in the Y direction, and cause movement in the X direction of the mold 100A/100B to be smooth, supporting the bottom surfaces of the mold 100A/100B (the bottom surfaces of the clamping plates 101a and 102a) and supporting the mold 100A/100B from below.

The width of the plurality of rollers 33 on the movable side is larger than the width of the plurality of rollers 33 on the fixed side. This configuration is common for the conveying machine 3A and the conveying machine 3B. The width indicates the length in the Y-axis direction. According to an improvement provided by an exemplary embodiment of the present disclosure as described below, even if the mold 100A/100B is replaced with another mold 100A/100B with a different width, it is not necessary to adjust the position of the plurality of rollers 33 in the Y-axis direction.

The control apparatus 4 includes a controller 41 for controlling the injection molding machine 2, a controller 42A for controlling the conveying machine 3A, and a controller 42B for controlling the conveying machine 3B. Each of the controllers 41, 42A and 42B includes, for example, a processor such as a CPU, a RAM, a ROM, a storage device such as a hard disk, and interfaces connected to sensors or actuators (not illustrated). The processor executes programs stored in the storage device. An example of a program (control) that the controller 41 executes is described below. The controller 41 is communicably connected with the controllers 42A and 42B, and provides instructions related to the conveyance of the mold 100A/100B to the controllers 42A and 42B. The controllers 42A and 42B, if loading and unloading of the mold 100A/100B terminates, transmit a signal for operation completion to the controller 41. In addition, the controllers 42A and 42B transmit an emergency stop signal at a time of an abnormal occurrence to the controller 41.

A controller is arranged for each of the injection molding machine 2, the conveying machine 3A, and the conveying machine 3B, but one controller can control all three machines. The conveying machine 3A and the conveying machine 3B can be controlled by a single controller for more reliable and collaborative operation.

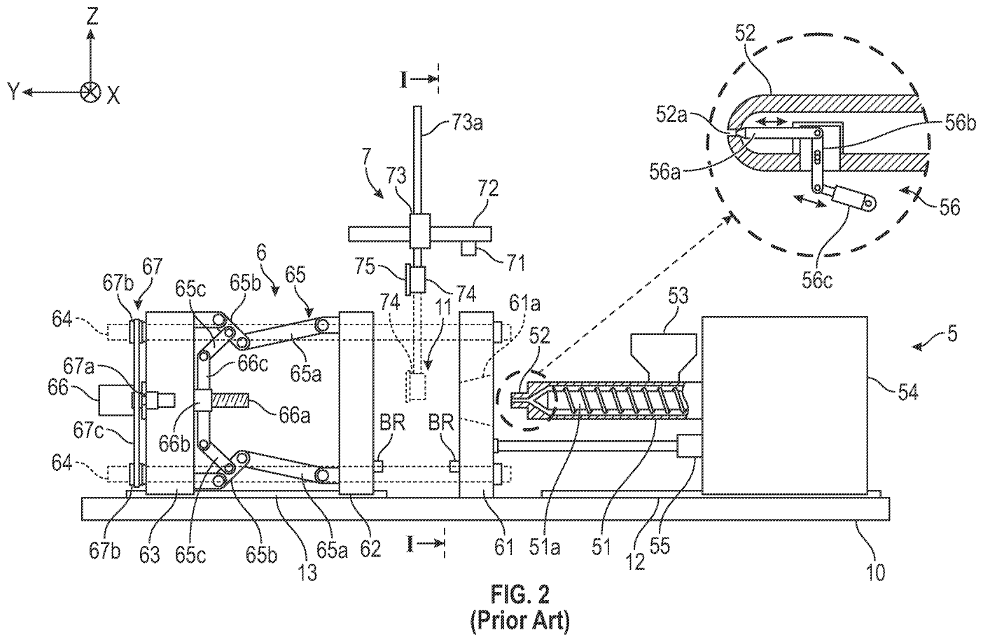

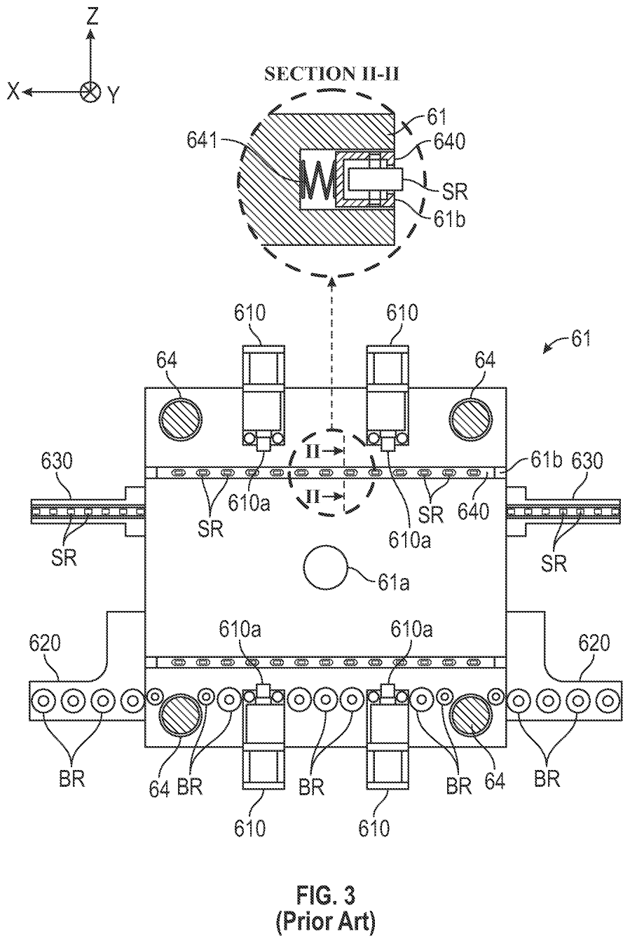

FIG. 2 illustrates a side view of the injection molding machine 2. FIG. 3 illustrates an end view of a fixed platen 61, and a figure viewing from the arrow direction of the I-I line in FIG. 2.

With reference to FIG. 1 and FIG. 2, the injection molding machine 2 includes an injecting apparatus 5, a clamping apparatus 6, and a take-out robot 7 for ejecting a molded part. The injecting apparatus 5 and the clamping apparatus 6 are arranged on a frame 10 in the Y-axis direction.

The injecting apparatus 5 includes an injection cylinder 51 that is arranged to extend in the Y-axis direction. The injection cylinder 51 includes a heating device (not illustrated) such as a band heater, and melts a resin introduced from a hopper 53. A screw 51a is integrated into the injection cylinder 51, and by rotation of the screw 51a, plasticizing and measuring the resin introduced into the injection cylinder 51 are performed, and by movement in the axial direction (Y-axis direction) of the screw 51a, it is possible to inject a molten resin from an injection nozzle 52.

In FIG. 2, an example of a shut-off nozzle as the nozzle 52 is illustrated. For an opening/closing mechanism 56 of FIG. 2, a pin 56a for opening/closing the discharge port 52a is arranged. The pin 56a is connected with an actuator (a cylinder) 56c via a link 56b, and by the operation of the actuator 56c the discharge port 52a is opened and closed.

The injection cylinder 51 is supported by a driving unit 54. In the driving unit 54, a motor for plasticizing and measuring the resin by rotationally drive the screw 51a, and a motor for driving the screw 51a to move forward/backward in the axial direction are arranged. The driving unit 54 can move forward/backward in the Y-axis direction along a rail 12 on the frame 10, and in the driving unit 54, an actuator (for example, an electrically driven cylinder) 55 for causing the injecting apparatus 5 to move forward/backward in the Y-axis direction is arranged.

The clamping apparatus 6 performs a clamping and opening and closing of the molds 100A/100B. In the clamping apparatus 6, the following are arranged in order in the Y-axis direction: the fixed platen 61, a movable platen 62, and a movable platen 63. Through platens 61 to 63, a plurality of tie-bars 64 pass. Each of the tie-bars 64 is an axis that extends in the Y-axis direction, one end of which is fixed to the fixed platen 61. Each of the tie-bars 64 is inserted into a respective through hole formed in the movable platen 62. The other end of each of the tie-bars 64 is fixed to the movable platen 63 through an adjusting mechanism 67. The movable platens 62 and 63 can move in the Y-axis direction along a rail 13 on the frame 10, and the fixed platen 61 is fixed to the frame 10.

A toggle mechanism 65 is arranged between the movable platen 62 and the movable platen 63. The toggle mechanism 65 causes the movable platen 62 to move forward/backward in the Y-axis direction in relation to the movable platen 63 (in other words, in relation to the fixed platen 61). The toggle mechanism 65 includes links 65a to 65c. The link 65a is connected rotatably to the movable platen 62. The link 65b is pivotably connected to the movable platen 63. The link 65a and the link 65b are pivotably connected to each other. The link 65c and the link 65b are pivotably connected to each other. The link 65c is pivotably connected to an arm 66c.

The arm 66c is fixed on a ball nut 66b. The ball nut 66b engages a ball screw shaft 66a that extends in the Y-axis direction, and moves forward/backward in the Y-axis direction by rotation of the ball screw shaft 66a. The ball screw shaft 66a is supported such that it is free to rotate by the movable platen 63, and a motor 66 is supported by the movable platen 63. The motor 66 rotationally drives the ball screw shaft 66a while the rotation amount of the motor 66 is detected. Driving the motor 66 while detecting the rotation amount of the motor 66 enables clamping, opening, and closing of the mold 100A/100B.

The injection molding machine 2 includes sensors 68 for measuring a clamping force, where each sensor 68 is, for example, a strain gauge provided on the tie-bar 64, and calculates a clamping force by detecting a distortion of the tie-bar 64.

The adjusting mechanism 67 includes nuts 67b supported to freely rotate on the movable platen 63, motors 67a as driving sources, and transfer mechanisms for transferring the driving force of the motors 67a to the nuts 67b. Each of the tie-bars 64 passes through a hole formed in the movable platen 63, and engages with the nut 67b. By causing the nuts 67b to rotate, the engagement positions in the Y-axis direction between the nuts 67b and the tie-bars 64 change. That is, the position at which the movable platen 63 is fixed in relation to the tie-bar 64 changes. With this, it is possible to cause a space between the movable platen 63 and the fixed platen 61 to change, and thereby it is possible to adjust a clamping force or the like.

The molding operation position 11 is a region between the fixed platen 61 and the movable platen 62.

The mold 100A/100B introduced into the molding operation position 11 are sandwiched between the fixed platen 61 and the movable platen 62 and thereby clamped. Opening and closing in based on movement of the movable mold 102 by movement of the movable platen 62 is performed.

The take-out robot 7 includes a rail 71 that extends in the X-axis direction and a movable rail 72 that can move in the X-axis direction on the rail 71. The movable rail 72 is installed to extend in the Y-axis direction and a slider 73 is provided on the movable rail 72. The slider 73 includes a function for moving in the Y-axis direction guided by the movable rail 72, and a function of moving an elevating shaft 73a up and down in the Z-axis direction. A vacuum head 74 is provided on the lower end of the elevating shaft 73a a, and a chuck plate 75 specialized to a molded part is mounted on the vacuum head 74. After opening, the take-out robot 7 moves the vacuum head 74 between the fixed mold 101 and the movable mold 102 as illustrated by the broken lines in FIG. 2 with the rail 71, the movable rail 72, and the slider 73, vacuums the molded part, and conveys it outside the injection molding machine 2. In another exemplary embodiment, the take-out robot is a type that grips the molded part mechanically.

FIG. 3 illustrates an opening portion 61a in a central portion of the fixed platen 61 through which the nozzle 52 moves forward/backward. To the surface on the side of the movable platen 62 (called an inner surface) of the fixed platen 61 a plurality of rollers BR are supported such that they are free to rotate. The plurality of rollers BR rotate around the axis of revolution in the Y-axis direction, and cause movement in the X-axis direction of the mold 100A/100B to be smooth, supporting the bottom surfaces (the bottom surface of the clamping plate 101a) of the mold 100A/100B and supporting the mold 100A/100B from below. On both sides in the X-axis direction of the fixed platen 61, a roller supporting body 620 is fixed, and the plurality of rollers BR are supported by the roller supporting body 620. On the inner surface of the fixed platen 61, grooves 61b that extend in the X-axis direction are formed.

The grooves 61b are formed in two rows separated vertically. On each of the grooves 61b a roller unit 640 is arranged. For the roller unit 640, a plurality of rollers SR are supported such that they are free to rotate. The plurality of rollers SR rotate around the axis of revolution in the Z-axis direction, and guide movement in the X-axis direction of the mold 100A/100B contacting the outer surfaces of the mold 100A/100B (the outer surface of the clamping plate 101a) and supporting the mold 100A/100B from the side. As illustrated in the cross sectional view of the line II-II, while the roller unit 640, by a bias of a spring 641, is positioned at a position at which the roller SR protrudes from the groove 61b, at a time of clamping it is retracted in the groove 61b, and positioned at a position at which the roller SR does not protrude from the groove 61b. The roller unit 640 can prevent the inner surfaces of the mold 100A/100B and the fixed platen 61 from contacting and damaging the inner surfaces at a time of alternating the mold 100A/100B, and the roller unit 640 does not impede the inner surface of the fixed platen 61 and the mold 100A/100B being closed at a time of clamping. On both sides in the X-axis direction of the fixed platen 61, a roller supporting body 630 is fixed, and a plurality of rollers SR are supported by the roller supporting body 630.

On the fixed platen 61, a plurality of fixing mechanisms (clamps) 610 are arranged for fixing the fixed mold 101 to the fixed platen 61. Each fixing mechanism 610 includes an engaging portion 610a that engages with the clamping plate 101a, and a built-in actuator (not illustrated) that moves the engaging portion 610a between an engagement position and an engagement release position.

Note that for the movable platen 62, similarly to the fixed platen 61, a plurality of rollers BR, the roller supporting bodies 620 and 630, the roller unit 640, and the fixing mechanism 610 for fixing the movable mold 102 are arranged.

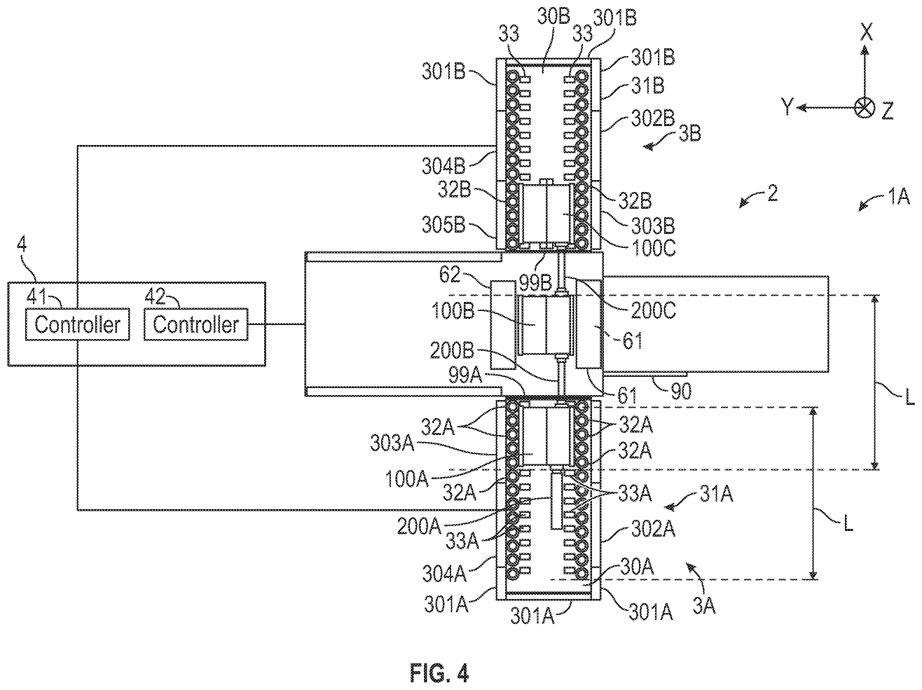

FIG. 4 illustrates an injection molding system 1A according an exemplary embodiment of the present disclosure. More specifically, the illustrated injection molding system 1A is an improvement to the injection molding system 1 described above. Some of the elements illustrated FIG. 4 are identical to those illustrated in FIG. 1. For description purposes of FIG. 4, some of the above-description may be repeated below for some of the illustrated elements. For those elements where the description(s) are not repeated, the above-description(s) are applicable.

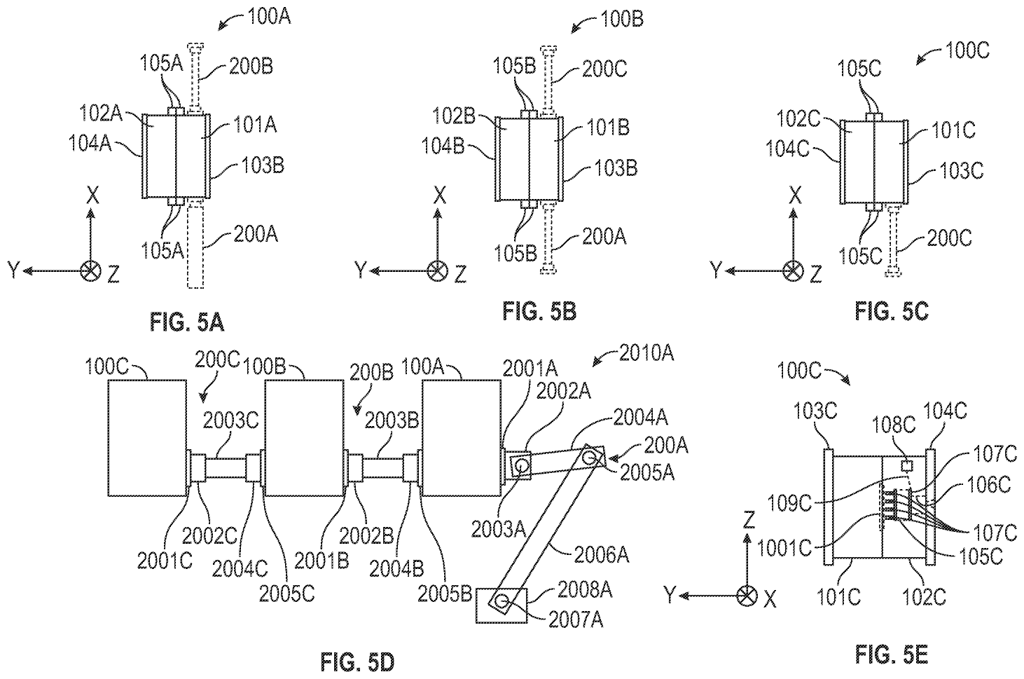

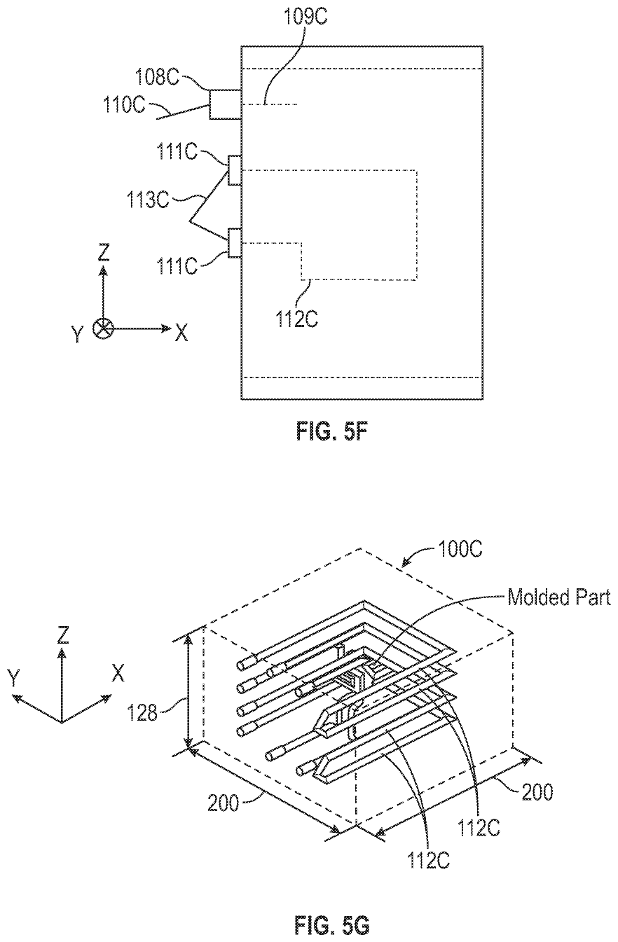

The injection molding system 1A includes an injection molding machine 2, conveying machines 3A and 3B, and a control apparatus 4. A plurality of molds are transported into and out of the injection molding machine 2 by the conveying machines 3A and 3B via openings provided on a first side surface and a second side surface opposite to the first side surface of the injection molding machine 2. Thus, a molded part can be manufactured while replacing molds with respect to the injection molding machine 2. In the present embodiment, three molds, 100A, 100B, and 100C, are arranged at a molding operation position 11 in a predetermined order, where an injection molding operation is executed with respect to each mold. The molds will be described in detail below with respect to FIGS. 5A-5C.

In one exemplary embodiment, mold 100A, mold 100B, and mold 100C are linked together and are integrally conveyed by an actuator (not illustrated) linked to any one of the molds. In another exemplary embodiment mold 100A, mold 100B, and mold 100C are linked in a row in this order, where a power supply cable and a temperature control liquid channel (not illustrated) that can be connected to the mold 100B positioned in the center are routed external to the injection molding machine 2 via a region between upper and lower tie bars (not illustrated) of the injection molding machine 2 and the side surface of the injection molding machine 2, and are connected to a power supply (not illustrated) and a temperature controller (not illustrated).

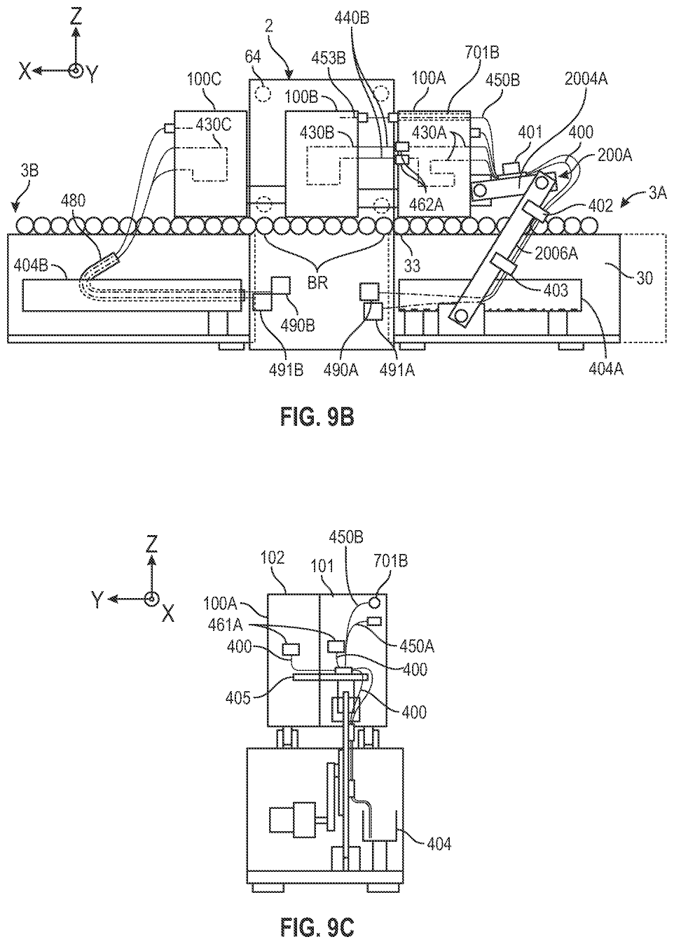

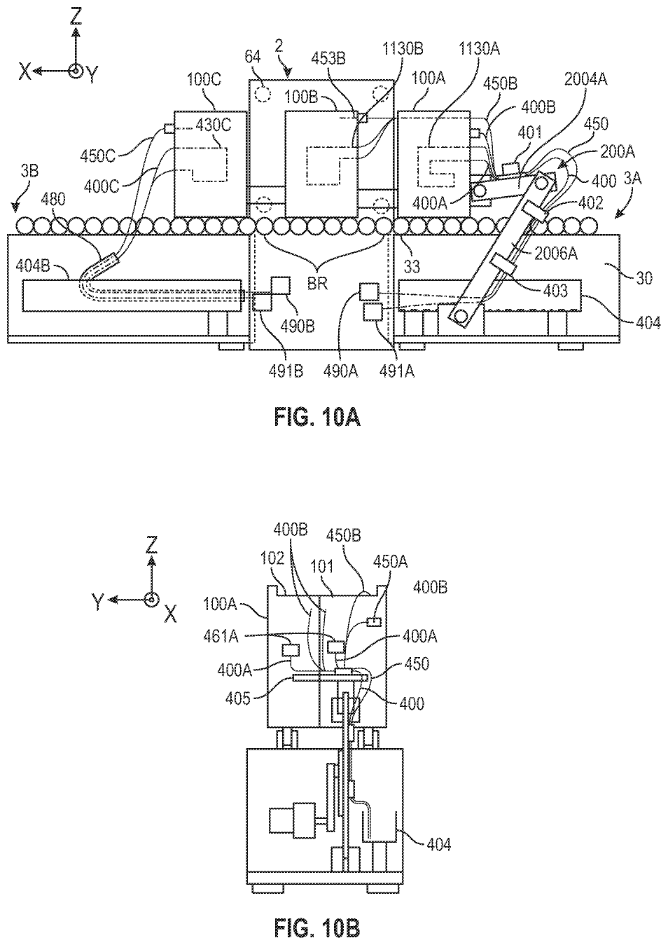

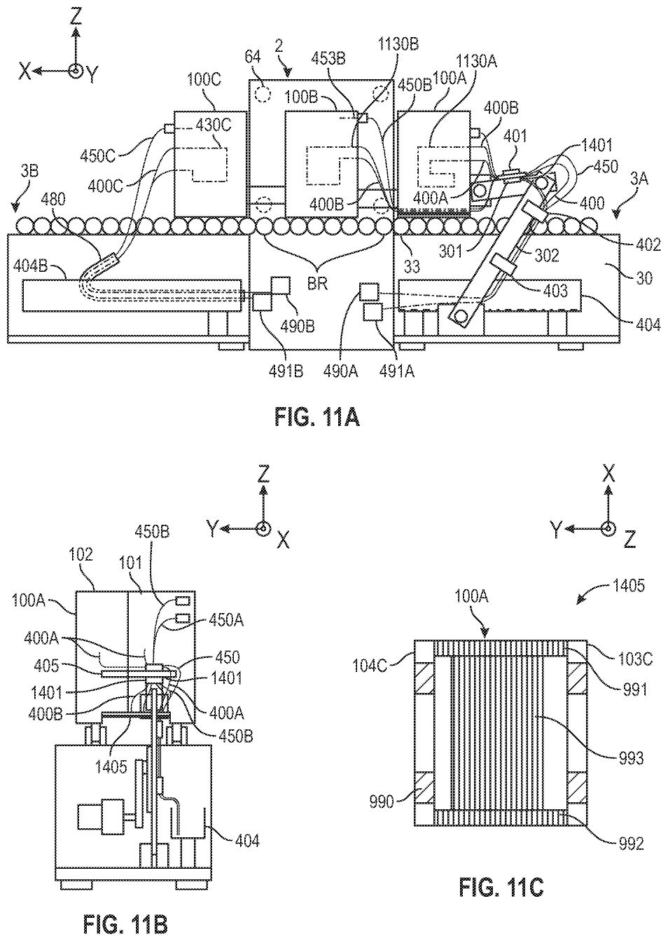

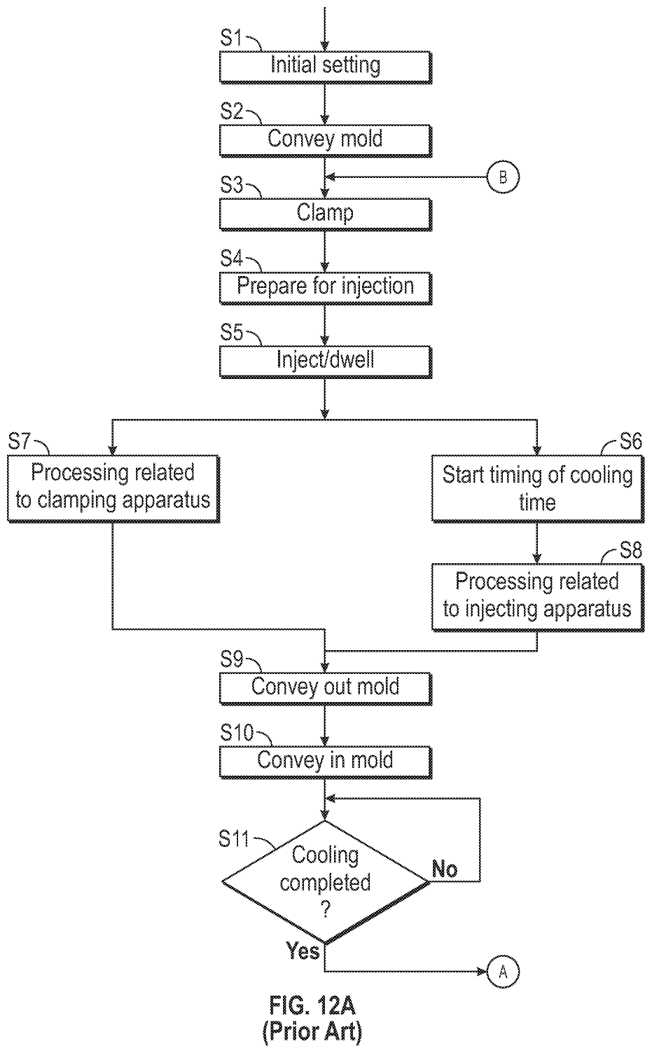

In the present embodiment, the power supply cable and the temperature control cooling liquid channel of the mold 100B are routed external to the injection molding machine 2 above or below either mold 100A or 100C. When the power supply cable and the temperature control cooling liquid channel of the mold 100B pass internally through mold 100A or mold 100C, a structure supporting this configuration will be provided in the respective mold. An example of this configuration will be described below with reference to FIGS. 9A through 9C. An example of a configuration where the power supply cable and the temperature control cooling liquid channel of the mold 100B pass above or below mold 100A or mold 100C will be described below with reference to FIGS. 10A-10B and 11A-11C.

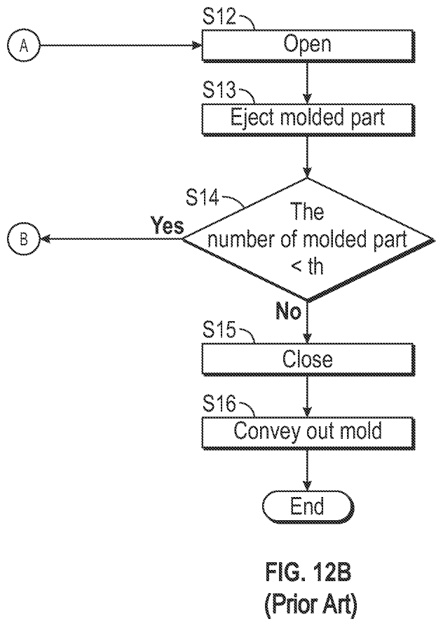

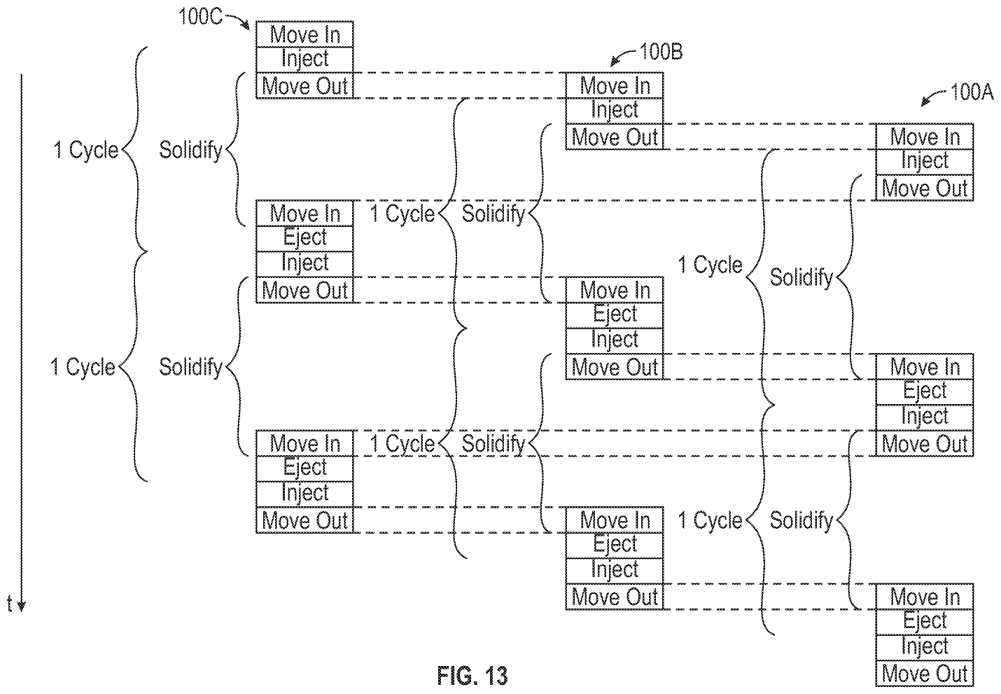

An example of a molding operation using the injection molding system 1A of the present embodiment will be described below with reference to the flowcharts of FIGS. 12A-12B and the timing chart of FIG. 13.

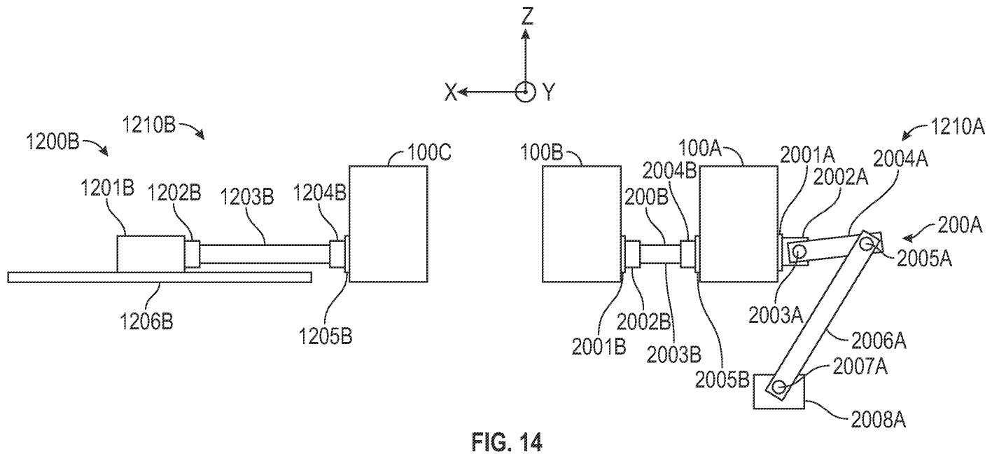

Another exemplary embodiment that includes a configuration example where three molds are conveyed by a plurality of actuators will be described below with reference to FIG. 14.

Turning to FIG. 4, the conveying machines 3A and 3B move molds 100A, 100B and 100C with respect to the injection molding machine 2. In the present embodiment, conveying machine 3A is provided with an actuator 200A. The conveying machine 3A also includes a metal frame 31A, a top plate 30A fixed horizontally with respect to the metal frame 31A, a plurality of bottom rollers 33A for supporting a lower part of a mold that are fixed to the top plate 30A, a plurality of side surface rollers 32A provided along the side surfaces of a mold to guide movement that are fixed to the top plate 30A, a wall panel 301A for covering the top plate, and door panels 302A, 303A, and 304A.

The plurality of bottom rollers 33A include a roller row arrayed in the X-axis direction. In the present embodiment, two rows are formed apart from each other in the Y-axis direction. The plurality of bottom rollers 33A rotate around the rotation axis of the Y-axis direction, and support, for example, the bottom surface (e.g., bottom surfaces of mounting plates 103A and 104A) of the mold 100A supporting the mold 100A from below to facilitate movement of mold 100A in the X-axis direction. The plurality of side rollers 32A include a row of rollers arranged in the X-axis direction. In the present embodiment, two rows are arranged apart from each other in the Y-axis direction. The plurality of side rollers 32A rotate about the Z-axis and contact, for example, the side surfaces (e.g., the outer surfaces of the mounting plates 103A and 104A) of mold 100A to support mold 100A from the sides and guide movement of the mold in the X-axis direction.

The bottom surface rollers 33A and the side surface rollers 32A form a conveyance path for a mold. This conveyance path functions as a retracting position of another mold when a mold is at the molding operation position 11, as well as a storage location when a mold is being set up. Therefore, the conveyance path should have a length longer than the length L in the X-axis direction when two molds are linked by a linking unit. The conveyance path of the conveying machine 3A is connected to the conveyance path inside the injection molding machine 2.

The top plate 30A is surrounded by the wall panel 301A and the door panels 302A, 303A, 304A, which restricts operator access when a mold is moving. In one embodiment the conveying machine 3A does not include a top, which enables the use of, a crane (not illustrated) to load a mold onto the conveying machine 3A. In this embodiment, the wall panel 301A and the door panels 302A, 303A, and 304A should be of sufficient height so that an operator standing next to the conveying machine 3A cannot access the mold and the actuator 200A inside the conveying machine 3A when the door panels 302A, 303A, and 304A are closed.

The actuator 200A is connected to the mold 100A and conveys molds 100A, 100B, and 100C. While any type of actuator can be used for the actuator 200A, an example using a link arm type actuator will be described in the present embodiment. As an example of a link arm type actuator, a motor as a driving source is provided under the top plate of the conveying machine 3A, and the rod of the actuator is arranged so as to protrude above the top plate 30A through a slit provided in the top plate 30A. The configuration enables reduction of the length of the conveying machine 3A in the X-axis direction compared to when using a linear actuator, which results in advantages in equipment miniaturization and cost.

Similar to the conveying machine 3A, the conveying machine 3B also includes a frame 31B, a top plate 30B fixed horizontally with respect to the metal frame 31B, a plurality of bottom surface rollers 33B fixed to the top plate 30B and supporting the lower part of a mold, a plurality of side surface rollers 32B fixed to the top plate 30B and provided along the side surfaces of a mold to guide movement, a wall panel 301B for covering the top plate 30B, and door panels 302B, 303B, 304B, and 305B. In the present embodiment, since no actuator is provided for the conveying machine 3B, conveying machine 3B cannot move a mold alone, and as such, it functions as a guiding unit for conveyance and a retracting unit for a mold.

The conveying machine 3B includes a conveyance path for a mold that is formed by the bottom surface rollers 33B and the side surface rollers 32B. This conveyance path of the mold functions as a retracting position of another mold when a mold is at the molding operation position 11, as well as a storage location when a mold is being set up. Therefore, the conveyance path should have a length longer than the length L in the X-axis direction when two molds are linked by a linking unit.

Sensors (not illustrated) for detecting an open/closed condition of the door panels 302A, 303A, 304A, 302B, 303B, 304B and 305B are provided for each door panel, and are connected to controller 41. This enables the status of the open/closed condition of a door panel to be provided via the control apparatus 4, so that, for example, when a door panel is opened during a molding operation or during a conveyance of a mold, the molding operation or the conveyance can be stopped or a warning can be issued. A door panel can also be provided with, for example, an electrically controllable locking mechanism. A door panel can also be locked during a mold conveyance or a molding operation to prevent contact between an operator and a moving mold. An alarm or a system status can be displayed on, for example, a monitor 90. In addition, an operator can be warned by activation of an audible alarm.

Control apparatus 4 includes a controller 42 to control the injection molding machine 2 and previously referenced controller 41 to the conveying machines 3A and 3B. Controller 41 and controller 42 communicate with each other. Both controller 41 and controller 42 include, for example, a processor such as a CPU, a storage device such as a RAM, a ROM, or a hard disk, and an interface connected to a sensor or an actuator, and execute a program (an example of which is described below) stored in the storage device. Controller 41 communicates with controller 42 and instructs controller 42 to convey 100A, mold 100B, and mold 100C. Controller 42 transmits an operation completion signal to controller 41 when the conveyance of a mold into and out of the injection molding machine 2 is completed. Controller 42 transmits an emergency stop signal to controller 41 when an abnormality in the injection molding process occurs.

Openings 99A and 99B provide for the insertion and removal of molds with respect to the injection molding machine 2. Since the conveying machines 3A and 3B are provided at openings 99A and 99B respectively, and they are both surrounded by respective wall panels 301A and 301B and door panels 302A, 303A, 304A and 302B, 303B, 304B, and 305B with predetermined heights, openings 99A and 99B are also covered by the respective wall panels 301A and 301B and door panels 302A, 303A, 304A and 302B, 303B, 304B, and 305B. This protects against an operator accidentally gaining access to the injection molding machine 2.

The molds 100A, 100B, and 100C and their linking mechanisms will be described with reference to FIGS. 5A-5G. In the following description, a mold with a hot runner will be described, but a following description will describe a mold with a cold runner.

Mold 100A according to an exemplary embodiment will be described with reference to FIG. 5A. Mold 100A includes a fixed mold or a fixed part 101A and a movable mold or movable part 102A, a mounting plate 103A of the fixed part 101A, a mounting plate 104A of the movable part 102A, and a self-closing unit 105A. Mold 100A is connected on a first side surface to an actuator 200A for conveying the mold 100A and to a linking unit 200B on a second side surface opposite the first side surface. The actuator 200A and the linking unit 200B will be described below with reference to FIG. 5D.

A molded part is molded by injecting molten resin into a cavity (described below) formed between the fixed mold 101A and the movable mold 102A.

The mounting plates 103A and 104A are used for locking the mold 100A into the molding operation position 11 of the injection molding machine 2. The mold 100A is provided with a self-closing unit 105A for maintaining the fixed mold 101A and the movable mold 102A in a closed state. The self-closing unit 105A prevents the mold 100A from opening even after the mold 100A is remove from the injection molding machine 2.

The self-closing unit 105A can be located at a plurality of locations along a mating surface of the fixed mold 101A and the movable mold 102A. In the present embodiment, the self-closing unit 105A is a combination of an element on the fixed mold 101A side and an element on the movable mold 102A side. For example, a combination of a permanent magnet and a magnetic material, a combination of permanent magnets. In other exemplary embodiments the self-closing unit 105A can be, an elastic deformation mechanism, or a mechanical mechanism.

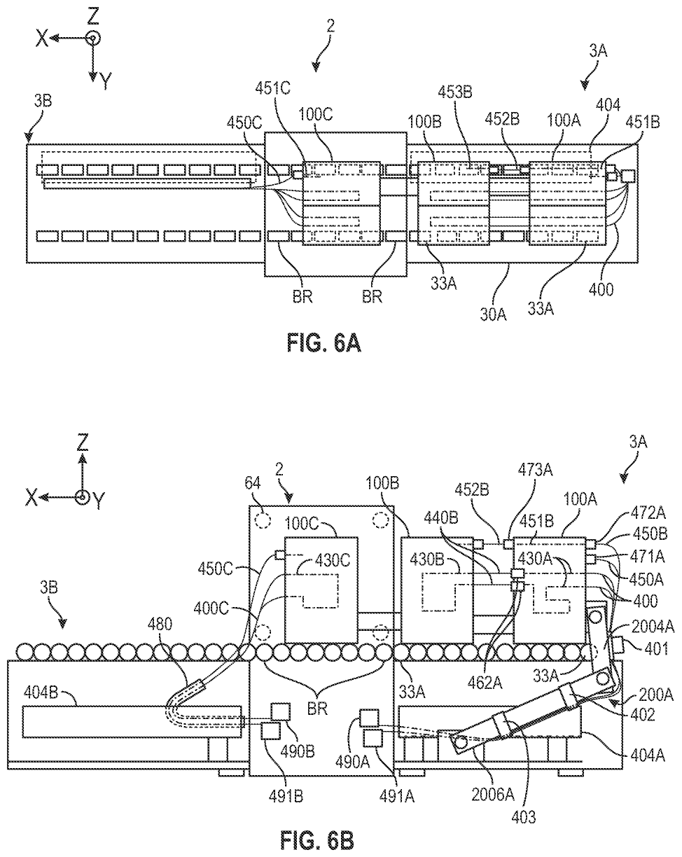

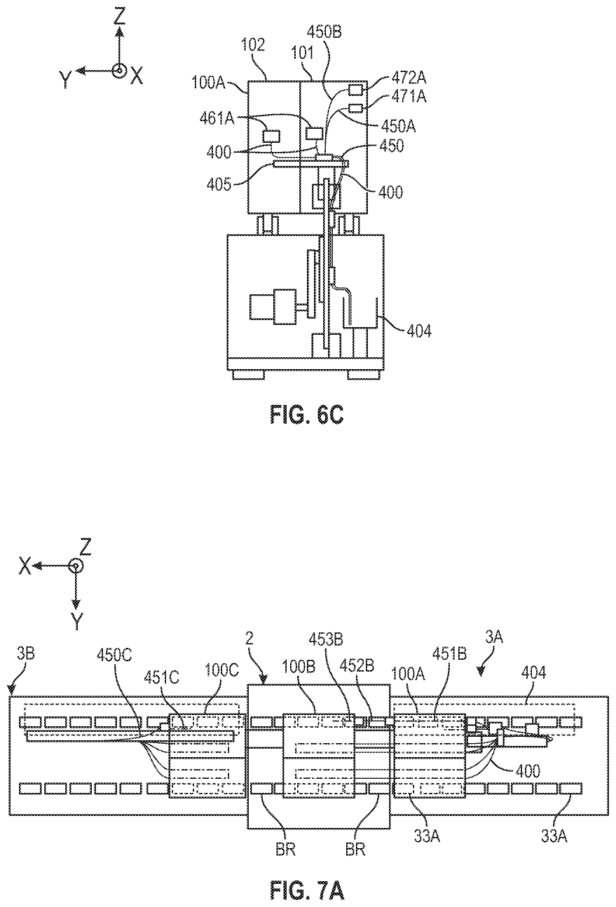

The internal structure of the mold 100A will be described below with reference to FIGS. 5E and 5F. The mold 100B will now be described with reference to FIG. 5B. Similar to the mold 100A, the mold 100B includes a fixed mold 101B, a movable mold 102B, a mounting plate 103B, a mounting plate 104B, and a self-closing unit 105B. The structure and function of each of these elements are the same as those of the mold 100A, description of these elements is omitted. In other exemplary embodiments, the internal structure of the mold 100B is different from the internal structure of the mold 100A. This will be described below with reference to FIG. 6.

The mold 100B is linked to the linking unit 200B on a first side surface. The mold 100B is linked to the mold 100A by the linking unit 200B. The mold 100B is linked to the actuator 200A via the linking unit 200B and the mold 100A. The mold 100B is linked to the linking unit 200C on a second side surface opposite the first side surface. The linking unit 200C will be described below with reference to FIG. 5D.

The mold 100C will be described with reference to FIG. 5C. The mold 100C includes a fixed mold 101C, a movable mold 102C, a mounting plate 103C, a mounting plate 104C, and a self-closing unit 105C similar to the elements of mold 100A and mold 100B. Since the structure and function of each of these elements are the same as those of the mold 100A and the mold 100B, the description of these elements are omitted herein.

The mold 100C is linked to the linking unit 200C on a first side surface. The mold 100C is linked to the mold 100A by the linking unit 200C. The mold 100C is linked to the actuator 200A via the linking unit 200C and the mold 100A. The mold 100C is linked to the linking unit 200C on a second side surface opposite the first side surface. The linking unit 200C will be described below with reference to FIG. 5D.

An example of the structures of the actuator 200A, the linking unit 200B, and the linking unit 200C will be described with reference to FIG. 5D. The actuator 200A is a driving element for conveying the molds 100A, 100B, and 100C, and in the present embodiment is a link arm type actuator. Actuator 200A includes a mounting part 2001A, a first rod 2002A, a first rotating part 2003A, a second rod 2004A, a second rotating part 2005A, a third rod 2006A, a third rotating part 2007A, and a motor 2008A.

The mounting part 2001A is a physical interface unit for attaching the actuator 200A to the mold 100A, and is detachably fixed to the mold 100A by, for example, screws. The first rod 2002A has a structure protruding nearly perpendicularly from a side surface of the mold 100A, is fixed to the mounting part 2001A, and supports the first rotating part 2003A. The first rotating part 2003A is a supporting part for supporting the first rod 2002A and the second rod 2004A so as to be relatively rotatable to each other, and can be fixed to either the first rod 2002A or the second rod 2004A. The first rotating part 2003A also functions as a fixing part or a linking part for relatively rotatably fixing and linking the first rod 2002A and the second rod 2004A.

The second rod 2004A is linked to the first rotating part 2003A and the second rotating part 2005A, and is rotatable with respect to the first rod 2002A. The second rotating part 2005A is a supporting part for supporting the second rod 2004A and the third rod 2006A so as to be relatively rotatable to each other, and can be fixed to either the second rod 2004A or the third rod 2006A. The second rotating part 2005A also functions as a fixing part or a linking part for relatively rotatably fixing and linking the second rod 2004A and the third rod 2006A. The third rod 2006A is linked to the second rotating part 2005A and the third rotating part 2007A, and is rotatable with respect to the second rod 2002A. The third rotating part 2007A is fixed to the third rod 2006A so as not to rotate, and is supported by the motor 2008A so as to be rotatable by receiving the rotational force of the motor 2008A. The third rotating part 2007A also functions as a fixing part or a linking part for relatively rotatably fixing and linking the third rod 2006A and the motor 2008A. The motor 2008A is a power source for rotating the third rotating part 2007A.

The motor 2008A of the actuator 200A can be arranged below the conveying machine 3A. The second rod 2004A and the third rod 2006A protrude above the top plate 30A from a slit provided near the center along the longitudinal direction of the top plate 30A of the conveying machine 3A, and are linked to the mold positioned above the top plate.

When the third rotating part 2007A is rotated counterclockwise by the motor 2008A, as in the state illustrated in FIG. 5D, one end of the third rod 2006A is moved in the positive X-axis direction by receiving a rotational force, and the second rod 2004A performs translational and rotational motions with the movement in question, thereby generating a force for pushing the first rod 2002A in the positive X-axis direction. This enables molds 100A, 100B, and 100C to be conveyed in the positive X-axis direction.

When the motor 2008A rotates the third rotating part 2007A clockwise, the first rod 2002A moves reversely in the X-axis negative direction, and the molds 100A, 100B, and 100C are conveyed in the X-axis negative direction with this movement. While the first rod 2002A and the mold 100A are subjected to a force in the positive Z-axis direction (vertically upward) along with the translational and rotational movement of the second rod 2004A, the mold 100A is not substantially lifted up because the weight of the group of molds is sufficiently large.

The linking unit 200B includes a first mounting plate 2001B on the mold 100B side, a first base part 2002B on the mold 100B side, a rod 2003B, a second base part 2004B on the mold 100A side, and a second mounting plate 2005B on the mold 100A side. The first mounting part 2001B is a physical interface part for mounting the mold 100B and the linking unit 200B, and is detachably fixed to the mold 100B by, for example, screws.

The first base part 2002B is a base portion for connecting the first mounting plate 2001B and the rod 2003B, and is fixed with respect to the mounting plate 2001B and the rod 2003B. The rod 2003B is the main structure of the linking unit 200B, and a material with a high rigidity such as a metal is used. The second base part 2004B is a base part for connecting the rod 2003B and the second mounting plate 2005B, and is fixed to the mounting plate 2005B and the rod 2004B. The second mounting plate 2005B is a physical interface part for mounting the mold 100A and the linking unit 200B, and is detachably fixed to the mold 100B by, for example, screws.

Either the first base part 2002B or the second base portion 2004B can have a pair of elements relatively movable in the Y-axis and Z-axis directions or around the Y-axis and Z-axis in order to absorb vibration occurring during a mold movement and to reduce the load on the actuator 200A. As a result, even if a force is applied to a mold in the Y-axis and Z-axis directions or around the Y-axis and Z-axis and a mold moves by only a small distance, the movement of the mold is absorbed by providing the pair of elements capable of relative movement, and the force transmitted to the actuator 200A can be reduced.

The linking unit 200C has a first mounting plate 2001C on the mold 100C side, a first base part 200C on the mold 100C side, a rod 2003C, a second base part 2004C on the mold 100B side, and a second mounting plate 2005C on the mold 100B side. Since these structures and functions are the same as those of the linking unit 200B, descriptions thereof are omitted herein.

Examples of the internal structure of mold 100C will be described with reference to FIGS. 5E and 5F. While FIGS. 5E and 5F illustrate the mold 100C, mold 100B can have a similar structure. FIG. 5E is a side view of the Y-Z plane of the mold 100C as viewed from the X-axis direction.

A cavity 1001C and a hot runner 105C are provided inside the fixed mold 102C. The cavity 1001C is a void provided between the fixed mold 101C and the movable mold 102C for receiving molten resin, and has the same outer shape as the part to be molded. The hot runner 105C includes a flow path structure 106C for providing molten resin into the cavity 1001C, a heater 107C for heating the flow path structure 106C and preventing the resin from hardening, a connector 108C to which a cable 110C for supplying electric power to the heater 107C is connected, and an internal cable 109C for supplying electric power from the connector 108C to the heater. A cooling liquid channel 112C for adjusting the temperature and hardening the molten resin in the cavity is three-dimensionally arranged in the mold 100C as described with reference to. FIGS. 5F and 5G.

FIG. 5F is a side view of the Z-X plane of the mold 100C viewed from the Y-axis direction. Connector 108C and the connection parts 111C of a liquid pipe (not illustrated) outside of the mold 100C are arranged on a first side surface of the mold 100C. In FIG. 5F, an external liquid pipe (not illustrated) is connected to one end of the liquid channel 112C inside the mold 100C via the connecting part 111C, the other end of the liquid channel 112C is connected to a connecting part 113C, and the connection part 111C is connected to another liquid pipe outside of the mold 100C. The liquid pipe is connected to a temperature regulator (not illustrated) and the temperature regulator supplies liquid adjusted to a specific temperature to the liquid pipe. Liquid of a specific temperature flows in or is supplied to the liquid channel 112C from an external liquid pipe, and flows out or is collected from another other liquid pipe.

The specific temperature in question varies depending on the type of the molten resin. For example, a general-purpose material such as ABS/HIPS has a cooling liquid temperature of 30° C., an engineering plastic resin including nylon/filler, etc., has a cooling liquid temperature of 80° C., and a super engineering plastic has a cooling liquid temperature of 120° C. The resin temperatures at the time of injection are 230° C., 300° C., and 400° C. respectively, and the solidification temperatures are 65° C., 140° C., and 180° C. respectively. Generally, the temperature of the cooling liquid in the liquid pipe is kept constant throughout an injection molding process.

FIG. 5G is a view illustrating an example of the structure of the liquid channels 112C inside the mold 100C. The liquid channels are arranged so as to surround the molded part or the cavity 1001C. FIGS. 5E, 5F, and 5G illustrate examples of the mold 100C, as well as the same apply to the mold 100B. The mold 100A can have the same or a different structure depending on a particular exemplary embodiment.

FIGS. 6A through 8C illustrate a configuration of an injection molding system according to exemplary embodiment and a method of conveying three molds. The descriptions and illustrations of the liquid pipe connection parts 111C illustrated in FIGS. 5E and 5F are omitted from the following description.

FIGS. 6A to 6C illustrate a state where the mold 100C is located in the molding operation position 11 in the injection molding system 1A according to the present embodiment.

In the present embodiment, the mold 100A has a partially different structure from the above-described molds 100B and 100C. In addition to a first connector 471A that is connected to an external power supply cable 450A for applying power to a hot runner of the mold 100A, the mold 100A includes a second connector 472A to which an external power supply cable 450B is connected, a power supply cable 451B that one end is connected to the second connector 472A and that passes through the inside of the mold 100A, and a third connector 473A that is connected to the other end of the power supply cable 451B. The second connector 472A is provided on a first side surface connected to an actuator in the same manner as the first connector 471A, but the third connector 473A is provided on a surface opposite to the first side surface, that is, the surface facing the mold 100B.

The power supply cable 452B connected to the mold 100B is connected to the third connector 473A of the mold 100A, the internal power supply cable 451B connected to the third connector 473A is connected to the second connector 472A, and the power supply cable 450B connected to the second connector 472A is connected to the power supply 490A arranged below the injection molding machine 2.

The mold 100A includes an internal liquid channel 430A that is connected to a connection part 461A for connecting to an external liquid pipe 400 that is connected to a temperature controller (not illustrated) on a first side surface connected to an actuator 200A, and also connected to another connection part 462A provided on a surface opposite to the first side surface, that is, a surface facing the mold 100B. The other connection part 462A is provided to supply cooling liquid to the mold 100B.

A liquid pipe 440B external to but connected to the mold 100B is connected to the liquid channel 430A inside the mold 100A, and the liquid channel 430A inside the mold 100A is connected to the liquid pipe 400 outside of the mold 100A. The liquid pipe 400 is connected to a temperature regulator 491A arranged below the injection molding machine 2.

On an outer surface of the second rod 2004A of the link arm type actuator 200A, a plate 405 is provided for regulating the arrangement of the power supply cables 450A and 450B or the liquid pipe 400. In addition, a clamp 401 for clamping the power supply cables 450A, 450B and the liquid pipe 400 is provided on the plate 405 so that the power supply cables 450A, 450B and the liquid pipe 400 do not separate from the second rod 2004A. In addition, on an outer surface of the third rod 2006A, clamps 402 and 403 for clamping the power supply cables 450A, 450B and the liquid pipe 400 are arranged side by side in the longitudinal direction of the third rod 2006A, so that the power supply cables 450A, 450B and the liquid pipe 400 do not separate from the third rod 2006A.

The power supply cable 450A, the power supply cable 450B, and the liquid pipe 400 are clamped by a cable clamp 401 on the plate 405 provided on the second rod 2004A and cable clamps 402 and 403 provided on the third rod 2006A, and are routed along a link type arm. The power supply cables 450A and 450B can be coupled by a coupler and connected to a power supply as one cable. The liquid pipe 400 can be a plurality of liquid pipes.

The power supply cables 450A, 450B and the water pipe 400 clamped by the clamp 403 are received by a receiving tray 404A as illustrated in FIG. 6C, and guided below the injection molding machine 2 along the bottom surface of the receiving tray 404A.

The liquid channel 430C inside the mold 100C is connected to the liquid pipe 400C outside of the mold 100C, and the liquid pipe 400C is connected to the temperature regulator 491B arranged below the injection molding machine 2. An external power supply cable 450C is connected to the connector of the mold 100C, and is connected to a power supply 490B below the injection molding machine 2. The liquid pipe 400C and the power supply cable 450C pass through a slit provided along the longitudinal direction of the top plate 30B of the conveying machine 3B and goes below the conveying machine 3B. A receiving tray 404B for cables and a cable carrier 480 are provided below the conveying machine 3B, and are guided to below the injection molding machine 2 through the cable carrier 480.

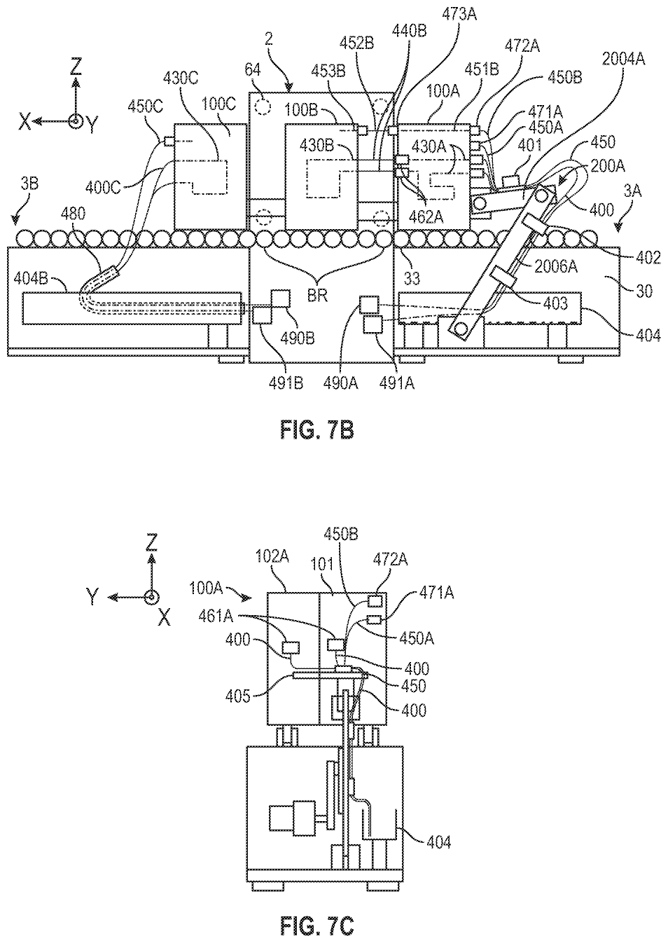

FIGS. 7A-7C illustrate a state where the mold 100B is at the molding operation position 11. FIG. 7A is a view illustrating of the injection molding system 1A viewed from the Z-axis direction, FIG. 7B is a side view illustrating the injection molding system 1A viewed from the Y-axis direction. FIG. 7C is a side view illustrating the injection molding system 1A viewed from the X-axis direction.

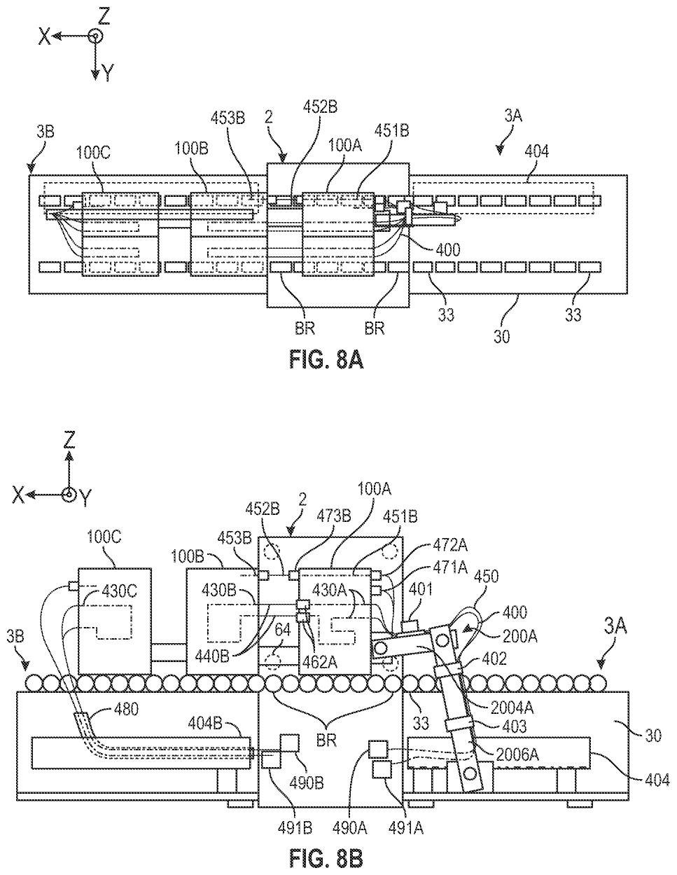

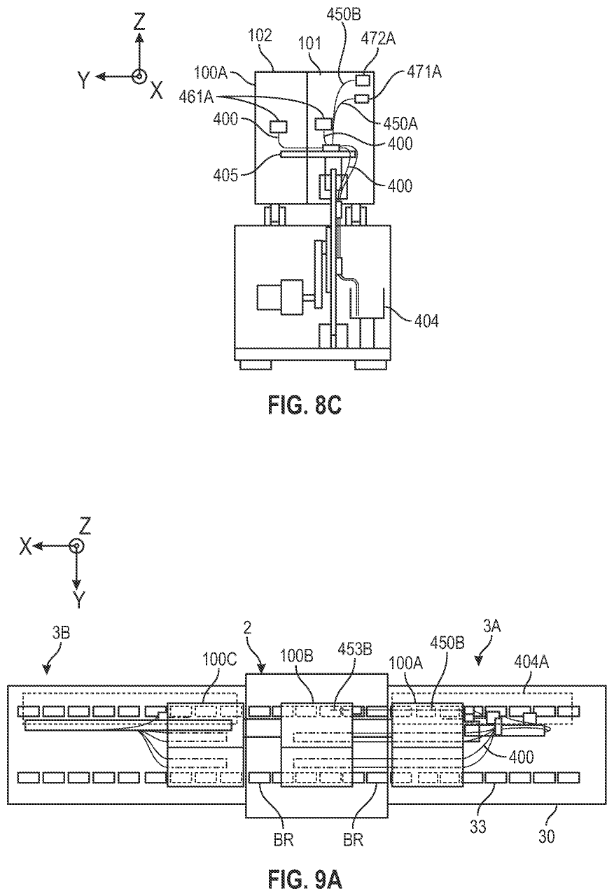

FIGS. 8A-8C illustrate a state where the mold 100A is in the molding operation position. FIG. 8A is a view illustrating the injection molding system 1A viewed from the Z-axis direction. FIG. 8B is a side view illustrating the injection molding system 1A viewed from the Y-axis direction. FIG. 8C is a side view illustrating the injection molding system 1A viewed from the X-axis direction.

In FIGS. 4A through 8C, the power supply cable and the liquid pipe(s) connected to the mold 100B are routed from the mold 100A side, connection parts between the connector of the power supply cable and the liquid pipe(s) are provided on a side surface of the mold 100B that is connected to a connection part 200B that is on a side surface of the mold 100B facing the mold 100A. For the mold 100C, since the power supply cable and the liquid pipe(s) are routed from a side of the mold 100C opposite to a side surface of the mold 100C to which the connection part 200C is connected, the connector of the power supply cable and the connection parts of the liquid pipe(s) are provided on the side surface opposite to the side surface to which the connection part 200C is connected.

In FIGS. 6A-6C, when the mold 100C is in the molding operation position 11, the mold 100B and the mold 100A are located on the conveying machine 3A to avoid the platens 61 and 62. In FIGS. 7A-7C, when the mold 100B is at the molding operation position 11, the mold 100C is located on the conveying machine 3B and the mold 100A is located on the conveying machine 3A to avoid the platens 61 and 62. In FIGS. 8A-8C, when the mold 100A is in the molding operation position 11, the molds 100C and 100B are located on the conveying machine 3B to avoid the platens 61 and 62. In the present embodiment, a retracted mold is located outside of the injection molding machine 2. In another exemplary embodiment, the retracted mold can be partially contained inside the injection molding machine 2 as long as it is retracted from the platen.

The above-described configurations enable, the power supply cable and liquid pipe(s) of a mold located at the center of the three molds are connected to one of the adjacent molds and are routed via these adjacent molds. The power supply cable and liquid pipe(s) of the mold located at the center of the three molds do not interfere with the four tie bars 64 of the injection molding machine 2 even when the mold is conveyed. Thus, the cable of the mold located at the center of the three molds can be prevented from interfering with the molding operation.

In FIGS. 4A-8C, the power supply cable for supplying power from the power source 490A to the mold 100B includes the power supply cable 452B, the power supply cable 451B inside the mold 100A, and the power supply cable 450B. The liquid pipe for supplying the cooling liquid from the temperature regulator 491A to the mold 100B includes a liquid pipe 440B, a liquid channel 430A inside of the mold 100A, and a liquid pipe 400.

The configuration of an injection molding system according to another exemplary embodiment will be described with reference to FIGS. 9A-9C. FIG. 9A illustrates a view of the injection molding system 1A viewed from the Z-axis direction, FIG. 9B illustrates a side view of the injection molding system 1A viewed from the Y-axis direction, and FIG. 9C illustrates a side view of the injection molding system 1A viewed from the X-axis direction. Since the liquid pipe connection parts 111C have previously been described, the description is omitted herein.

In the above-described embodiment, the mold 100A is provided with the second connector 472A and the third connector 473A. In the present embodiment, the mold 100A is provided with holes 701B penetrating through two side surfaces of the mold 100A, where the power supply cable 450B is connected to the connector of the mold 100B via the hole 701B, and to the cable 453B inside the mold 100B. The hole 701B penetrates a side surface of the mold 100A to which the link arm type actuator 200A is connected and a surface opposite to this side surface and facing the mold 100B. The hole 701B can be provided above the side surface of the mold 100A and close to the mounting plate 103A so as not to interfere with other structures of the mold 100A. The hole 701B functions as a guiding part or a position regulating part of the power supply cable 450B that is connected to the mold 100B.

For the liquid channels, the liquid channel 430A inside the mold 100A and the liquid channel 430B inside the mold 100B are connected by the liquid pipe 440B, and cooling liquid is supplied to and collected from the mold 100B via the mold 100A, in the same manner as in the above-described embodiment. This prevents interference with the four tie bars 64 of the injection molding machine 2 during the conveyance of a mold, and prevents a cable of the central mold from hindering the molding operation. According to the present embodiment, it is possible to realize an appropriate arrangement of the power cable by providing only a hole without providing the structure of an electric system inside the fixed mold.

The configuration of an injection molding system according to another exemplary embodiment will be described with reference to FIGS. 10A-10B. FIG. 10A illustrates a side view of the injection molding system 1A viewed from the Y-axis direction, and FIG. 10B illustrates a side view of the injection molding system 1A viewed from the X-axis direction. The present embodiment can be applied to, for example, the mold 100A adjacent to the mold 100B when there is an area sufficient for passing the power supply cable 450B and the liquid pipe 400B above the fixed unit 101A and the movable unit 102A and between the mounting plates 103A and 104A. The power supply cable 450B and the liquid pipe 400B are passed through this area to connect the mold 100B, the power source 490A, and the temperature regulator 491A. In this embodiment, a special structure in the mold 100A is not needed, and a mold having the same structure as the mold 100B can be used as the mold 100A.

The configuration of an injection molding system according to another exemplary embodiment will be described with reference to FIGS. 11A-11C. FIG. 11A illustrates a side view of the injection molding system 1A viewed from the Y-axis direction, FIG. 11B illustrates a side view of the injection molding system 1A viewed from the X-axis direction, and FIG. 11C illustrates a view of the mold 100A viewed vertically from below. The present embodiment can be applied to one of the molds 100A adjacent to the mold 100B when there is an area sufficient for passing the power supply cable 450B and the water pipe 400B under the fixed unit 101A and the movable unit 102A as well as between the mounting plates 103A and 104A. The power supply cable 450B and the liquid pipe 400B can be passed through the area to connect the mold 100B, the power source 490A, and the temperature regulator 491A.

In the present embodiment, a mold of a special structure as the mold 100A is not needed. A plate 1405 for regulating the downward shift of the power supply cable 450B and the liquid pipe 400B is provided in the area. The plate 1405 is fixed to the mounting plates 103A and 104A to avoid the area clamped by the clamping mechanisms of the platens 61 and 62 on the mounting plates 103A and 104A.

FIG. 11C illustrates, for example, the plate 1405 including a first beam 991, a second beam 992, and a cable support part 993 supported by the first beam 991 and the second beam 992. The first beam 991 is provided along a first side surface of the mold 100A, and is fixed to the inner surfaces of the mounting plates 103A and 104A with bolts or the like. The second beam 992 is provided along a second side surface opposite to the first side surface of the mold 100A, and is fixed to the inner surfaces of the mounting plates 103A and 104A with bolts or the like. A support part 993 is fixed to the first beam 991 and the second beam 992 from the second side surface side by bolts or the like. For example, in this manner, the first beam 991, the second beam 992, and the support part 993 are provided so as not to interfere with the area 990 clamped by the clamps of the platens 61 and 62 and with the range of motion of the clamps.

The plate 1405 functions as a guiding part for guiding the position of the power supply cable 450B and the liquid pipe 400B, or as a regulating part for regulating the power supply cable 450B and the liquid pipe 400B. The regulating part and the guiding part are not limited to the plate 1405, and in another exemplary embodiment can be provided with a cable carrier.

The above-described configuration enables preventing interference with the four tie bars 64 of the injection molding machine 2 during mold conveyance, as well as preventing a cable of the central mold from hindering the molding operation. In addition, the configuration of the present embodiment, enables using a regular mold without changing the internal structure of the mold.

When the rigidity of the power supply cable 450B and the liquid pipe 400B is sufficiently high and does not greatly buckle under the mold, the regulating part or the guiding part does is not necessarily needed if it can be seen to potentially interfere with the injection molding system 1A.

The processing flow performed with one mold from among the molds 100A, 100B, 100C will be described with reference to the flowchart of FIGS. 12A-12B. FIGS. 12A-12B illustrate an injection molding operation associated with US2018/0009146/Japanese patent publication No. 2018-001738/VN20160002505 and is being provided herein for information, description, and exemplary purposes only. The flow of the process performed by the injection molding machine 2 will be described below with reference to the timing chart of FIG. 13. Control apparatus 4 of the injection molding system 1A executes the following processes.

### Molded Part Manufacturing Example

The following description will describe the process associated with the mold 100A. Mold 100A is being used for convenience of describing the process and is applicable to mold 100B and mold 100C.

An initial setting is performed in step S1. The operation conditions of the injecting apparatus 5 and the clamping apparatus 6 are registered for mold 100A. The operation conditions include, but are not limited to, the amount of resin that is injected at one time, the temperature, the injection speed, the clamping force, the initial value of the position of the movable platen 63 in relation to the tie-bars 64, etc. Because the mold 100A is used for a first molding operation, the operations conditions related to the mold 100A are automatically set as the operation conditions, but can be different for other molds. Heating of the injection cylinder 51 and plasticizing and measuring of the resin and the like for the first time is also started.

In step S2, the mold 100A is conveyed into the injection molding machine 2. The motor 66 is driven to widen the gap between the fixed platen 61 and the movable platen 62 to slightly wider than the thickness of the mold 100A (the width in the Y direction). Next, the controller 41 transmits an instruction to load the mold 100A to the controller 42A, and the controller 42A drives the conveyance unit 31 to load the mold 100A into the molding operation position 11. The mold 100A is unloaded and the mold 100B loaded at the same time. When loading of the mold 100A completes, a signal indicating load completion is transmitted from the controller 42A to the controller 41. When the signal indicating load completion is received, the motor 66 is driven to bring the fixed platen 61 and the movable platen 62 into close contact with the mold 100A. At this time it is not necessary to generate a clamping force as it is generated to occur during a molding. The mold 100A is locked to each of the fixed platen 61 and the movable platen 62 by driving the fixing mechanisms 610.

In step S3, clamping of the mold 100A by the fixed platen 61 and the movable platen 62 is performed by driving the motor 66 to drive the toggle mechanism 65. Preparation for injection in relation to the mold 100A is performed. The actuator 55 is driven to move the injecting apparatus 5, causing the nozzle 52 to contact the mold 100A.

In step S4, the nozzle of the injection apparatus 5 advances in the positive Y-axis direction and is brought into contact with the mold 100A. An actuator 55 is driven to move the injection apparatus 5, and the nozzle 52 contacts with the mold 100A. In addition, an injection molding preparation process is performed.

In step S5, injection and dwelling of molten resin is performed. More specifically, the injecting apparatus 5 is driven to fill molten resin into a cavity in the mold 100A from the nozzle 52, and to press the resin in the cylinder 51 into the mold 100A at a high pressure in order to compensate for a volume decrease due to the resin solidifying. The actual clamping force is measured by the sensor 68. During molding, the mold 100A thermally expands due to the temperature of the mold 100A gradually rising, and there are cases where a difference arises in the initial clamping force and the clamping force after some time has passed. Thus, it is possible to correct the clamping force at the time of the next clamping based on a result of measurement by the sensors 68.

The adjustment of the clamping force is performed by an adjustment of the position of the movable platen 63 in relation to the tie-bar 64 by driving the motor 67. This enables enhancing precision of the clamping force by adjusting the clamping force by correcting the initial value of the position of the movable platen 63 in relation to the tie-bars 64 based on the result of measurement by the sensors 68. The adjustment of the position of the movable platen 63 in relation to the tie-bars 64 can be performed at any timing.

The processing of step S6 and step S8 is performed in parallel to step S7. In step S6, the timing of the cooling time for the molded part in the mold 100A is started. In step S7, processing related to the clamping apparatus 6 is performed. More specifically, locking of the mold 100A by the fixing mechanism 610 is released. After a delay of a predetermined time from step S5, the motor 66 is driven to drive the toggle mechanism 65. This results in removal of the clamping force, the movable platen 62 separates slightly in relation to the fixed platen 61, and a space facilitating alternating the molds is formed.

In step S8, processing related to the injecting apparatus 5 is performed. For example, a dwelling suck back, a nozzle shut-off, a retraction of the injecting apparatus 5 or the like are performed. The dwelling suck back and the nozzle shut-off prevent the molten resin from dripping when the nozzle 52 separates from the mold 100A. These processes can be performed during a delay time prior to causing the movable platen 62 to separate slightly in relation to the fixed platen 61 in step S7.

The dwelling suck back reduces the resin pressure in the injection cylinder 51 and in the mold 100A when, after the dwelling, the screw 51a is retracted. The position to which the screw 51a is retracted in the dwelling suck back can be managed as an absolute position, and can be managed as a relative position in relation to a position of the screw 51a after dwelling completion. The screw 51a can be caused to retract until it is detected that the resin pressure measured by a load cell (not illustrated) installed in the injecting apparatus 5 is reduced to a predetermined pressure.

The nozzle shut-off closes the discharge port 52a of the nozzle 52, and in the example of FIG. 2, the pin 56a closes the discharge port 52a. This operation enables suppressing the leaking of resin. The precision of the measuring of the resin can be improved for the next injection. The foregoing processing provides to prevent the resin from leaking, but there are cases where long threadlike resin is generated between the mold 100A and the nozzle 52 due to the structure of the mold 100A or the type of resin. An apparatus for injecting air into the nozzle 52 can be installed to prevent this from occurring.

In step S9, alternation of the mold 100A with another mold is performed. The mold 100A is unloaded from the molding operation position 11 to the conveying machine 3A, and, for example, the mold 100B is loaded from the conveying device 3B to the molding operation position 11. The controller 41 transmits an instruction to unload the mold 100A to the controller 42, and the controller 42 drives the conveyance unit 31 to unload the mold 100A from the molding operation position 11. When unloading of the mold 100A completes, a signal indicating unloading completion is transmitted from the controller 42 to the controller 41. The mold 100A is cooled on the conveying machine 3A. At this time, the closed state of the mold 100A is maintained due to the operation of the self-closing unit 103.

In step S10, the conveying machine 3A re-conveys the mold 100A into the molding operation position 11 based on completion of the cooling time. In step S11, a determination is made whether the cooling of the mold 100A has completed based on whether the cooling time from the start of the time measurement in step S6 has reached a predetermined time. If the cooling is completed, the process proceeds to step S12.

In step S12, the motor 66 is driven to separate the movable platen 62 from the fixed platen 61. Since the fixed mold 101 is fixed to the fixed platen 61 by the clamps 610 and the movable mold 102 is fixed to the movable platen 62 by the clamps 610, the movable mold 102A is separated from the fixed mold 101A, and the mold 100A is opened. In step S13, the take-out robot 7 is driven to remove the molded part remaining in the movable mold 102A side of the mold 100A and to convey the molded part external to the injection molding machine 2. A vacuum head 74 is moved to a position where the chuck plate 75 faces the molded part and the molded part is vacuumed and secured.

In step S14, a determination is made whether the molding of a required number Th of molded parts has been completed. If the number of finished molded parts is less than the threshold Th, molding has not completed. If the number of finished molded parts is greater than or equal to the threshold Th, molding is determined to be completed. If the molding is determined to not be completed, the process returns to step S3, and the above-described process repeats. If the molding is determined to be completed, the process proceeds to step S15.

In step S15, the mold clamping device 6 clamps the mold 100A. In step S16, the conveying machine 3A conveys the mold 100A. Thereafter, the power supply cable and the liquid pipes are detached from the mold 100A and the mold 100A is unloaded from the conveying machine 3A.

A processing sequence of the injection molding machine 2 will be described with reference to the timing chart of FIG. 13. The injection molding process will be described in the order of the molds 100C, 100B, and 100A.

The mold 100C is conveyed into the injection molding machine 2 by the actuator 200A of the conveying machine 3A. FIGS. 6A-6C, for example, illustrate a state immediately after this conveyance operation. After injection and dwelling are performed by the injection apparatus 5 and the mold clamping device 6, the mold 100C is removed from the molding operation position 11 by the actuator 200A and moved onto the conveying machine 3B (this process is described in the flowcharts of FIGS. 12A-12B).

In parallel to the removal of the mold 100C, the mold 100B connected to the mold 100C is conveyed from the conveying machine 3A to the molding operation position 11. FIGS. 7A-7C, for example, illustrate a state immediately after the conveyance operation. Thereafter, injection and dwelling are performed by the injection apparatus 5 and the mold clamping device 6. The mold 100B is then removed from the molding operation position 11 by the actuator 200A and moved onto the conveying machine 3B.

In parallel to the removal of the mold 100B, the mold 100A connected to the mold 100B is conveyed from the conveying machine 3A to the molding operation position 11. FIGS. 8A-8C, for example, illustrate a state immediately after this conveyance operation. Thereafter, injection and dwelling are performed by the injection apparatus 5 and the mold clamping device 6. The mold 100A is then removed from the molding operation position 11 by the actuator 200A and returned to the conveying machine 3A.

The actuator 200A continues to operate, and the mold 100B also passes through the molding operation position 11 from the conveying machine 3B and moves onto the conveying machine 3A. The mold 100C is conveyed into the molding operation position 11 from the conveying machine 3B. This results in a return to the state of FIGS. 6A-6C.

After it is determined that the cooling of the mold 100C is completed, the resulting molded part is removed from the mold 100C by the take-out robot 7. Removal of the molded part marks completion of one cycle of an injection molding operation of the mold 100C. In this cycle, cooling occurs from immediately after the injection step to immediately before the removal step.

Injection and dwelling are performed again with respect to the mold 100C by the injection apparatus 5 and the clamping device 6. The mold 100C is removed from the molding operation position 11 by the actuator 200A, and moved onto the conveying machine 3B. In parallel, the mold 100B that is connected to the mold 100C is conveyed from the conveying machine 3A to the molding operation position 11. This results in a return to the state of FIGS. 5A-5G.

After it is determined that the cooling of the mold 100B is completed, the resulting molded part is removed from the mold 100B by the take-out robot 7. Removal of the molded part marks completion of one cycle of an injection molding operation of the mold 100B. In this cycle, cooling occurs from immediately after the injection step to immediately before the removal step.

Injection and dwelling are performed again with respect to the mold 100B by the injection apparatus 5 and the clamping device 6. The mold 100B is removed from the molding operation position 11 by the actuator 200A and moved onto the conveying machine 3B. In parallel, the mold 100A that is connected to the mold 100B is conveyed from the conveying machine 3A to the molding operation position 11. This results in a return to the state of FIGS. 8A-8C.

After it is determined that the cooling of the mold 100A is completed, the resulting molded part is removed from the mold 100A by the take-out robot 7. Removal of the molded part marks completion of one cycle of an injection molding operation of the mold 100A. In this cycle, cooling occurs from immediately after the injection step to immediately before the removal step.

Injection and dwelling are performed again with respect to the mold 100A by the injection apparatus 5 and the clamping device 6. The mold 100A is removed from the molding operation position 11 by the actuator 200A and moved onto the conveying machine 3A. In addition, the actuator 200A continues to operate, the mold 100B also passes through the molding operation position 11 from the conveying machine 3B and moves onto the conveying machine 3A, and the mold 100C is carried into the molding operation position 11 from the conveying machine 3B. This results in a return to the state of FIGS. 6A-6C.

As described above, during a period where the resin is cooled for one mold, the removal and injection processes for other molds are performed. This enables an injection molding machine to be efficiently operated and productivity to be improved. The injection molding process of the present embodiment for linking three molds is suitable for a molded part with a relatively long cooling period.

In the above described-embodiment, an example of three molds being moved by one actuator was illustrated, however, this configuration is not seen to be limiting. In another exemplary embodiment, three molds can be moved by two actuators. This exemplary embodiment will be described with reference to FIG. 14.

In FIG. 14, for the molds 100A and 100B, the actuator 200A is linked to the mold 100A in the same manner as in the above-described embodiment, while the mold 100B is linked to the mold 100A by the linking unit 200B. The mold 100C is linked to the actuator 1200B instead of to the mold 100B. In the present embodiment, the actuator 1200B is linear type actuator and is provided in the conveyance machine 3B. In another exemplary embodiment, a link arm type actuator, such as the actuator 200A, can be used.

The actuator 1200B includes a motor built in a movable part 1201B for moving on a linear guide 1206B. A rod 1203B is fixed to the movable part 1201B via a first base part 1202B. One end of the rod 1203B is fixed to the first base part 1202B and another end is fixed to the second base part 1204B. The second base part 1204B is linked to the mold 100C via the mounting plate 1205B.

The above-described configuration provides for the power supply cable and the liquid pipes of the mold 100B are arranged on the mold 100A side and connected to a power source and temperature regulator by implementing the configuration of the above-described embodiment(s). In the present embodiment, since two actuators are provided, the conveyance of the molds 100A and 100B can be independently carried out in a time division manner to the conveyance of the mold 100C. That is, for example, when the mold 100C is conveyed from the molding operation position 11 onto the conveying machine 3B by the actuator 1200B, the actuator 200A can be activated to start conveyance of the mold 100B into the molding operation position 11, after the mold 100C is conveyed out of the molding operation position 11.

In the above-described embodiment(s), the power supply cable and the liquid pipes are examples of linear structures connected to a mold. An air pipe for driving a pin inside a mold can also be connected to a central mold from one side in a similar fashion as the power supply cable and the liquid pipes.

In the above-described embodiment(s), a mold including a hot runner has been discussed. In another exemplary embodiment, a cold runner type mold can also be used. In the case of a cold runner type mold, it is desirable that the actuator is linked to the mounting plate on the fixed side of the mold. In addition, a heater, such as a hot runner, typically does not exist internal to the mold, where only the liquid pipes or the liquid pipes and the air pipes are connected to the mold.

The above-described embodiment(s) discuss alternating/replacing three molds with respect to one injection molding machine. In another exemplary embodiment, four or more molds can be used. In this embodiment, the arrangement of the power supply cable and the liquid pipes for two molds (If the molds A, B, C, and D are arranged in this order, the molds other than A and D which are arranged at the end, that is, the molds B and C) are arranged at the ends can be realized based on the above-described embodiment(s), e.g., if molds A, B, C, and D are arranged in this order, the molds other than A and D that are arranged at the end, that is, the molds B and C. That is, the power supply cable and the liquid pipes of the mold B can be routed from the mold A side between the upper and lower tie bars and through the opening on a side of the injection molding machine. The power supply cable and the liquid pipes of the mold C can be routed from the mold D side between the upper and lower tie bars and through the opening on a side of the injection molding machine.

The embodiment(s) illustrated in FIGS. 6A-11C, describe an example where a cable clamp is provided on the second rod 2004A and the third rod 2006A, which are movable parts of the actuator 200A. In another exemplary embodiment, the cable clamp can be provided on an external structure of the injection molding machine 2, such as, for example, the top plate 30A or the frame 31 of the conveying machine 3A.

In the above-described embodiments, ant reference to an exterior area of the injection molding machine 2 can refer to an area enclosed by a pair of platens 61, 62, and four tie bars, which can indicate the area that includes the molding operating position 11.

### Definitions

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. An injection molding system comprising:
an injection molding machine including at least one opening on each of a first side surface and a second side surface for conveying at least one mold;
wherein the improvement to the injection molding system includes:
at least one actuator for conveying at least three different molds through at least one of the at least one openings; and
at least one guiding element for guiding at least one cable connected to a first mold located between at least two other molds to a location external to the injection molding machine via an opening of the injection molding machine.

2. An injection molding system according to claim 1, wherein the at least one guiding element guides the at least one supply cable so that the at least one supply cable remains independent of a tie bar of the injection molding machine.

3. An injection molding system according to claim 1, wherein the at least one guiding element is provided in a mold adjacent to the first mold.

4. An injection molding system according to claim 3, wherein the at least one guiding element is a hole located in the mold adjacent to the first mold.

5. An injection molding system according to claim 1, wherein the at least one guiding element is located on an upper surface of a mold adjacent to the first mold.

6. An injection molding system according to claim 1, wherein the at least one guiding element is a plate fixed below a lower surface of a mold adjacent to the first mold.

7. An injection molding system according to claim 1, wherein the at least one guiding element is a cable carrier for guiding the at least one supply cable to the opening of the injection molding machine while avoiding the mold adjacent to the first mold.

8. An injection molding system according to claim 1, wherein the at least one guiding element includes at least one cable clamp located external to the injection molding machine.

9. An injection molding system according to claim 8, wherein the at least one cable clamp is provided on a movable part of the at least one actuator.

10. An injection molding system according to claim 1, further comprising at least one linking unit for linking at least three molds with at least one of the at least one actuator.

11. An injection molding system according to claim 1, wherein one of the at least one actuator is an actuator for conveying one mold from at least three molds and another actuator of the at least one actuator is an actuator for conveying any remaining molds from among the at least three molds.

12. An injection molding system according to claim 1, wherein the at least one cable comprises a group of pipes including a liquid pipe for supplying cooling water, a power supply cable for supplying power, and an air pipe for supplying air.

13. A mold for injection molding comprising:
a first side surface connected to an actuator that conveys the mold;
a first connection part located on the first side surface to which a pipe containing a cooling liquid is connected;
a second side surface opposite the first side surface;
a first liquid channel located inside the mold and connected to the first connection part; and
a second connecting part located on the second side surface for connecting the pipe to a second liquid channel located inside a different mold linked to the mold.

14. A mold for injection molding comprising:
a hot runner located inside the mold;
a first side surface connected to an actuator that conveys the mold;
a second side surface opposite the first side surface;
a first connector located on the first side surface to which a power supply cable for supplying power to the hot runner is connected;
a second connector located on the first side surface;
a third connector located on the second side surface; and
a power supply cable located inside the mold that electrically connects the second connector and the third connector.

15. An injection molding system comprising:
an injection molding machine including at least one opening on each of a first side surface and a second side surface for conveying at least one mold;
wherein the improvement to the injection molding system includes:
at least one actuator for conveying at least three molds linked together in a row through at least one of the at least one opening; and
a guiding element for guiding at least one cable connected to a first mold that is centered between at least two other molds to a location external to the injection molding machine via an opening of the injection molding machine.
